(19) United States
(12) Patent Application Publication
(10) Pub. No.: US 2026/0146894 A1
(43) Pub. Date: May 28, 2026

(54) SENSING DEVICE AND OPERATION METHOD THEREOF

(71) Applicant: United Microelectronics Corp., Hsinchu (TW)

(72) Inventors: Chi-Chung CHEN, Tainan City (TW); Chia-Jung Chang, Tainan City (TW)

(21) Appl. No.: 18/957,938

(22) Filed: Nov. 25, 2024

(51) Int. Cl. G01J 5/00

(52) U.S. Cl. CPC G01J 5/0025

(57) ABSTRACT

A sensing device and an operation method thereof are provided. The sensing device includes a Passive Infrared (PIR) sensor, a radiation emitter and a controller. The PIR sensor includes a plurality sensing elements. The PIR sensor is used to detect a heat source. The controller is connected to the radiation emitter and the PIR sensor. The controller enables the radiation emitter to emit a radiation light to the PIR sensor when the sensing elements reach a voltage balance for a predetermined time and then disables the radiation emitter.

### TECHNICAL FIELD

The disclosure relates in general to an electronic device and an operation method thereof, and more particularly to a sensing device and an operation method thereof.

### BACKGROUND

A passive infrared sensor (PIR sensor) is an electronic sensor that measures infrared (IR) light radiating from objects in its field of view. They are most often used in PIR-based motion detectors. The PIR sensor is commonly used in security alarms and automatic lighting applications.

In traditional, the PIR sensor detects a moving heat source, such as a human body. However, when the heat source stays still, the PIR sensor cannot detect it. Therefore, the traditional PIR sensor cannot be used in many scenarios.

### SUMMARY

The disclosure is directed to a sensing device and an operation method thereof. A radiation light is used to make a voltage imbalance and a voltage balance on a Passive Infrared sensor (PIR sensor), so a static heat source could make another voltage imbalance on the PIR sensor. Even if the heat source stays still, the static heat source could be detected by the sensing device of the present disclosure.

According to one embodiment, a sensing device is provided. The sensing device includes a Passive Infrared (PIR) sensor, a radiation emitter and a controller. The PIR sensor includes a plurality sensing elements. The PIR sensor is used to detect a heat source. The controller is connected to the radiation emitter and the PIR sensor. The controller enables the radiation emitter to emit a radiation light to the PIR sensor when the sensing elements reach a voltage balance for a predetermined time and then disables the radiation emitter.

According to another embodiment, an operation method of a sensing device is provided. The operation method of the sensing device includes the following steps. A radiation emitter is enabled to emit a radiation light to a Passive Infrared (PIR) sensor when a plurality of sensing elements of the PIR sensor reach a voltage balance for a predetermined time. The radiation emitter is disabled after the radiation emitter is enabled.

### BRIEF DESCRIPTION OF THE DRAWINGS

FIGS. 1A to 1C illustrate different implementation examples for a sensing device according to one embodiment of the present disclosure.

FIG. 2 shows a block diagram of the sensing device according to one embodiment of the present disclosure.

FIG. 3 shows a circuit diagram of the PIR sensor according to one embodiment of the present disclosure.

FIG. 4 shows an operation method of the sensing device according to one embodiment of the present disclosure.

FIGS. 5A to 5J illustrate the steps described in the FIG. 4.

FIG. 6 shows the operation method of the sensing device according to another embodiment of the present disclosure.

FIGS. 7A to 7D illustrate the steps described in the FIG. 6.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

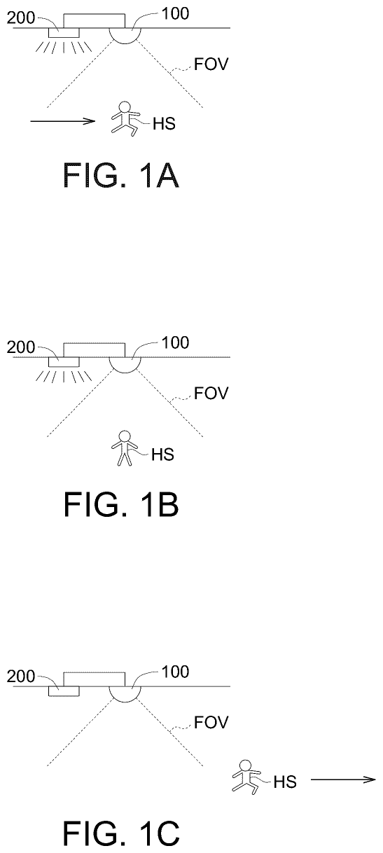

Please refer to FIGS. 1A to 1C, which illustrate different implementation examples for a sensing device 100 according to one embodiment of the present disclosure. The sensing device 100 could be installed on the ceiling or the wall. The sensing device 100 has a field of view FOV. As shown in the FIG. 1A, when a heat source HS, such as a human body, enters the field of view FOV, the moving heat source HS is detected by the sensing device 100 of the present disclosure, and then an electronic device 200, such as a lamp, is controlled to be turned on.

As shown in the FIG. 1B, when the heat source HS stays still in the field of view FOV, the static heat source HS could be detected by the sensing device 100 of the present disclosure, and then the electronic device 200, such as the lamp, is controlled to be turned on.

As shown in the FIG. 1C, when the heat source HS leaves the field of view FOV, no heat source HS could be detected by the sensing device 100 of the present disclosure, and then the electronic device 200, such as the lamp, is controlled to be turned off.

In the embodiment of the present disclosure, even if the heat source HS stays still in the field of view FOV, the static heat source HS could be detected by the sensing device 100 of the present disclosure.

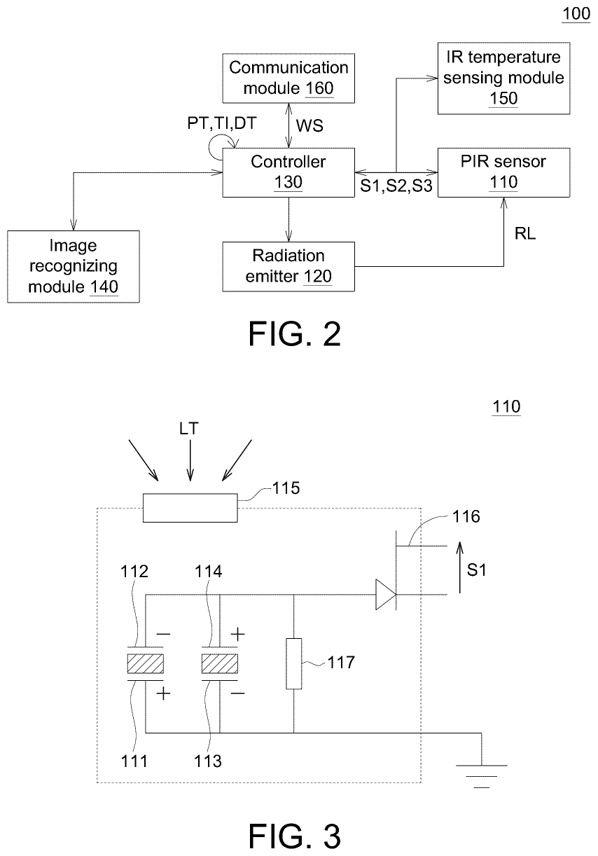

Please refer to FIG. 2, which shows a block diagram of the sensing device 100 according to one embodiment of the present disclosure. The sensing device 100 includes a Passive Infrared sensor (PIR sensor) 110, a radiation emitter 120, a controller 130, an image recognizing module 140, an Infrared (IR) temperature sensing module 150 and a communication module 160. The PIR sensor 110 is used to receive and measure the infrared (IR) light radiating from objects in its field of view FOV. The radiation emitter 120 is used to emit light, radiation, energy or heat. The radiation emitter 120 is fixed without rotating, and faces the PIR sensor 110. The controller 130 is used to execute various controlling procedures, processing procedures and computing procedures. The image recognizing module 140 is used to execute an image recognizing procedure. The IR temperature sensing module 150 is used to execute a temperature sensing procedure. The communication module 160 is used to transmit or receive various data.

The controller 130 and/or the image recognizing module 140 is, for example, a circuit, a circuit board, a storage device storing program codes or a chip. The chip is, for example, a central processing unit (CPU), a programmable general-purpose or special-purpose micro control unit (MCU), a microprocessor, a digital surge signal processor (DSP), a programmable controller, an application specific integrated circuit (ASIC), a graphics processing unit (GPU), an image surge signal processor (ISP), an image processing unit (IPU), an arithmetic logic unit (ALU), a complex programmable logic device (CPLD), an embedded system, a field programmable gate array (FPGA), other similar element or a combination thereof.

The communication module 160 is, for example, a wireless communication module or a wire communication module.

Please refer to FIG. 3, which shows a circuit diagram of the PIR sensor 110 according to one embodiment of the present disclosure. The PIR sensor 110 includes, for example, a plurality of sensing elements 111, 112, 113, 114, an optical filter 115, a transistor 116 and a resistor 117. A light LT emitted from the heat source HS is received by the PIR sensor 110. The light LT passes through the optical filter 115 and then projects on the sensing elements 111, 112, 113, 114. The energy of the light LT will charge one or more of the sensing elements 111, 112, 113, 114. Once one or more sensing elements 111, 112, 113, 114 is/are charged, a voltage imbalance would form among the sensing elements 111, 112, 113, 114 and a surge signal S1 would be generated at the transistor 116. For example, when the heat source HS is moving in the field of view FOV (shown in the FIG. 1A), the light LT emitted from the heat source HS would change the charges on the sensing elements 111, 112, 113, 114 and the voltage imbalance would be formed.

If charging on the sensing elements 111, 112, 113, 114 is completed or no charging is executed on the sensing elements 111, 112, 113, 114, a voltage balance would be form among the sensing elements 111, 112, 113, 114 and no surge signal would be generated at the transistor 116. For example, when no heat source HS is in the field of view FOV (shown in the FIG. 1C), no light LT could change the charges on the sensing elements 111, 112, 113, 114 and the voltage balance would be formed.

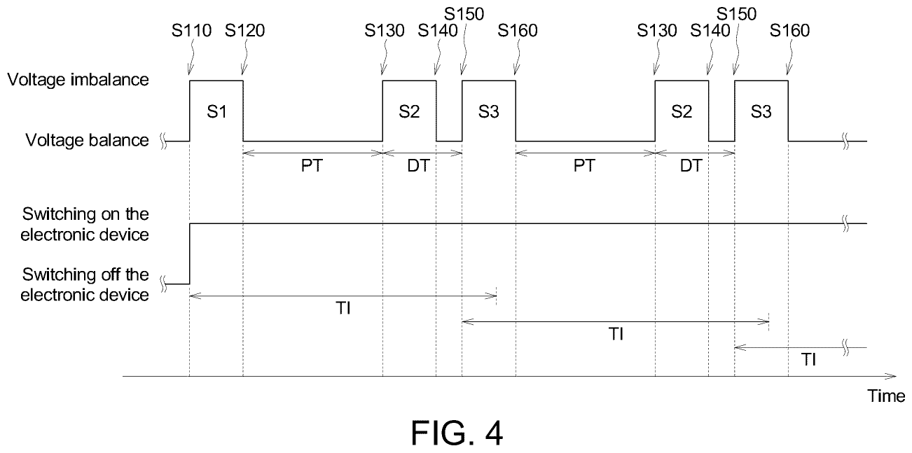

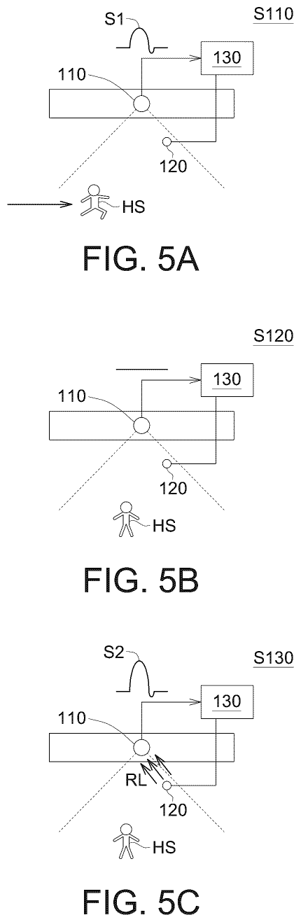

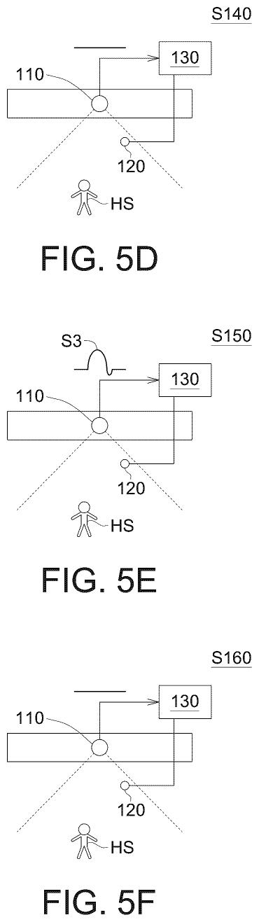

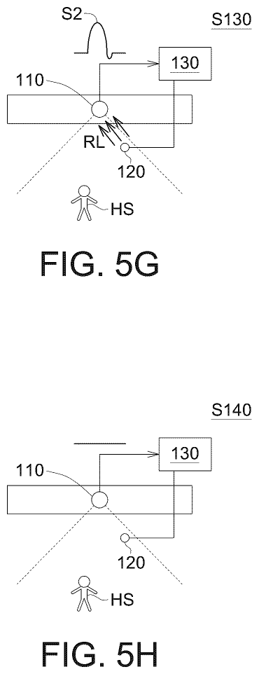

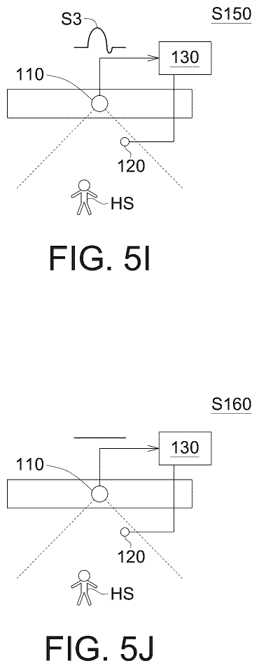

Please refer to FIGS. 4 to 5J. FIG. 4 shows an operation method of the sensing device 100 according to one embodiment of the present disclosure. FIGS. 5A to 5J illustrate the steps described in the FIG. 4. The operation method of the sensing device 100 includes steps S110 to S160.

At the step S110, as shown in the FIGS. 4 and 5A, the heat source HS enters the field of view FOV, and the moving heat source HS emits the light LT to the sensing elements 111, 112, 113, 114 in different direction, so the voltage imbalance is formed and the surge signal S1 is generated. The controller 130 receives the surge signal S1, and then controls the electronic device 200 to be turned on for a time interval TI.

Then, at the step S120, as shown in the FIGS. 4 and 5B, the heat source HS stays still, and charging on the sensing elements 111, 112, 113, 114 is completed, so the voltage balance would be form among the sensing elements 111, 112, 113, 114 and no surge signal would be generated. Because the end of the time interval TI is not arrived yet, so the electronic device 200 is kept being switched on.

Next, at the step S130, as shown in the FIGS. 4 and 5C, the controller 130 enables the radiation emitter 120 to emit a radiation light RL to the PIR sensor 110 when the PIR sensor 110 reaches the voltage balance for a predetermined time PT. The predetermined time PT is less than the time interval TI. An energy received from the radiation light RL of the radiation emitter 120 is larger than an energy received from the heat source HS. At this step, one or more of the sensing elements 111, 112, 113, 114 will be charged by the radiation light RL. Once one or more sensing elements 111, 112, 113, 114 is/are charged, the voltage imbalance would form among the sensing elements 111, 112, 113, 114 and a surge signal S2 would be generated. The surge signal S2, which is not caused by the heat source HS, is ignored by the controller 130. At this time, the end of the time interval TI is not arrived yet, so the electronic device 200 is kept being switched on.

Then, at the step S140, as shown in the FIGS. 4 and 5D, the radiation light RL is still emitted within the default time DT, and charging on the sensing elements 111, 112, 113, 114 is completed, so the voltage balance would be form among the sensing elements 111, 112, 113, 114 and no surge signal would be generated. At this time, because the end of the time interval TI is not arrived yet, so the electronic device 200 is kept being switched on.

Afterwards, at the step S150, as shown in the FIGS. 4 and 5E, the controller 130 disables the radiation emitter 120 after the radiation emitter 120 emits the radiation light RL for the default time DT. At this step, the heat source HS stays still in the field of view FOV, and the static heat source HS emits the light LT to the sensing elements 111, 112, 113, 114, so the voltage imbalance is formed again and the surge signal S3 is generated. The controller 130 receives the surge signal S3, and then controls the electronic device 200 to be turned on for another time interval TI.

Then, at the step S160, as shown in the FIGS. 4 and 5F, the heat source HS stays still, and charging on the sensing elements 111, 112, 113, 114 is completed, so the voltage balance would be form among the sensing elements 111, 112, 113, 114 and no surge signal would be generated. Because the end of the another time interval TI is not arrived yet, so the electronic device 200 is kept being switched on.

Next, at the step S130, as shown in the FIGS. 4 and 5G, the controller 130 enables the radiation emitter 120 to emit the radiation light RL to the PIR sensor 110 when the PIR sensor 110 reaches the voltage balance for another predetermined time PT. At this step, one or more of the sensing elements 111, 112, 113, 114 will be charged by the radiation light RL. Once one or more sensing elements 111, 112, 113, 114 is/are charged, the voltage imbalance would form among the sensing elements 111, 112, 113, 114 and the surge signal S2 would be generated. The surge signal S2, which is not caused by the heat source HS, is ignored by the controller 130. At this time, the end of the time interval TI is not arrived yet, so the electronic device 200 is kept being switched on.

Then, at the step S140, as shown in the FIGS. 4 and 5H, the radiation light RL is still emitted within the default time DT, and charging on the sensing elements 111, 112, 113, 114 is completed, so the voltage balance would be form among the sensing elements 111, 112, 113, 114 and no surge signal would be generated. At this time, because the end of the time interval TI is not arrived yet, so the electronic device 200 is kept being switched on.

Afterwards, at the step S150, as shown in the FIGS. 4 and 5I, the controller 130 disables the radiation emitter 120 after the radiation emitter 120 emits the radiation light RL for another default time DT. At this step, the heat source HS stays still in the field of view FOV, and the static heat source HS emits the light LT to the sensing elements 111, 112, 113, 114, so the voltage imbalance is formed again and the surge signal S3 is generated. The controller 130 receives the surge signal S3, and then controls the electronic device 200 to be turned on for another time interval TI.

Then, at the step S160, as shown in the FIGS. 4 and 5J, the heat source HS stays still, and charging on the sensing elements 111, 112, 113, 114 is completed, so the voltage balance would be form among the sensing elements 111, 112, 113, 114 and no surge signal would be generated. Because the end of the another time interval TI is not arrived yet, so the electronic device 200 is kept being switch on.

According to the embodiment described in the FIG. 4 and the FIG. 5A to 5J, the radiation light RL is used to make the voltage imbalance and the voltage balance on the PIR sensor 110, so the static heat source HS could make another voltage imbalance on the PIR sensor 110. Even if the heat source HS stays still in the field of view FOV, the static heat source HS could be detected by the sensing device 100 of the present disclosure and the electronic device 200 could be kept being switched on.

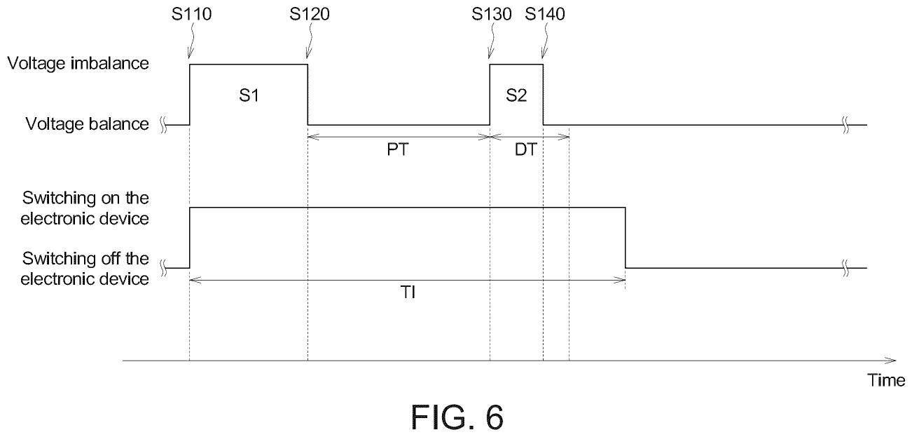

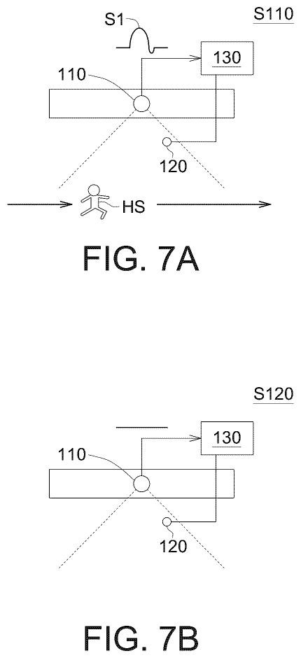

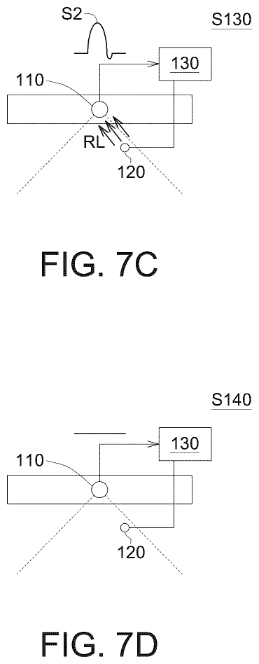

Please refer to FIGS. 6 to 7D. FIG. 6 shows the operation method of the sensing device 100 according to another embodiment of the present disclosure. FIGS. 7A to 7D illustrate the steps described in the FIG. 6.

At the step S110, as shown in the FIGS. 6 and 7A, the heat source HS passes through the field of view FOV, and the moving heat source HS emits the light LT to the sensing elements 111, 112, 113, 114 in different direction, so the voltage imbalance is formed and the surge signal S1 is generated. The controller 130 receives the surge signal S1, and then controls the electronic device 200 to be turned on for the time interval TI.

Then, at the step S120, as shown in the FIGS. 6 and 7B, the heat source HS has left the field of view FOV, and charging on the sensing elements 111, 112, 113, 114 is completed, so the voltage balance would be form among the sensing elements 111, 112, 113, 114 and no surge signal would be generated. Because the end of the time interval TI is not arrived yet, so the electronic device 200 is kept being switched on.

Next, at the step S130, as shown in the FIGS. 6 and 7C, the controller 130 enables the radiation emitter 120 to emit the radiation light RL to the PIR sensor 110 when the PIR sensor 110 reaches the voltage balance for the predetermined time PT. At this step, one or more of the sensing elements 111, 112, 113, 114 will be charged by the radiation light RL. Once one or more sensing elements 111, 112, 113, 114 is/are charged, the voltage imbalance would form among the sensing elements 111, 112, 113, 114 and the surge signal S2 would be generated. The surge signal S2, which is not caused by the heat source HS, is ignored by the controller 130. At this time, the end of the time interval TI is not arrived yet, so the electronic device 200 is kept being switched on.

Then, at the step S140, as shown in the FIGS. 6 and 7D, the radiation light RL is still emitted within the default time DT, and charging on the sensing elements 111, 112, 113, 114 is completed, so the voltage balance would be form among the sensing elements 111, 112, 113, 114 and no surge signal would be generated. At this time, because the end of the time interval TI is not arrived yet, so the electronic device 200 is kept being switch on.

Afterwards, as shown in the FIGS. 6 and 7D, there is no heat source HS in the field of view FOV, so the voltage balance is kept and no surge signal could be generated. When the end the time interval TI is arrived, the electronic device 200 will be turned off.

According to the embodiment described in the FIG. 6 and the FIG. 7A to 7D, if the heat source HS has left the field of view FOV, the electronic device 200 will be turned on for the time interval TI only.

As shown in the FIG. 2, the electronic device 200 mentioned before could be the image recognizing module 140 or the IR temperature sensing module 150. For example, when the heat source HS is detected, the image recognizing module 140 would be turned on to recognize whether a human body, i.e., the heat source HS, wears the helmet or not. If the human body does not wear the helmet, the controller 130 generates a warning signal WS through the communication module 160.

For another example, when the heat source HS is detected, the image recognizing module 140 would be turned on to recognize whether a human body, i.e. the heat source HS, passes out or falls. If the human body passes out or falls, the controller 130 generates the warning signal WS through the communication module 160.

For another example, when the heat source HS is detected, the image recognizing module 140 would be turned on to recognize whether a human body, i.e. the heat source HS, wears the face mask or not. If the human body does not wear the face mask, the controller 130 generates the warning signal WS through the communication module 160.

For another example, when the heat source HS is detected, the image recognizing module 140 would be turned on to recognize whether there is a crowd gathering. If there is the crowd gathering, the controller 130 generates the warning signal WS through the communication module 160.

For another example, when the heat source HS is detected, the image recognizing module 140 would be turned on to recognize whether a human body, i.e. the heat source HS, enters a no entry area. If the human body enters the no entry area, the controller 130 generates the warning signal WS through the communication module 160.

For another example, when the heat source HS is detected, the IR temperature sensing module 150 would be turned on to recognize whether a fire is happened or not. If the fire is happened, the controller 130 generates the warning signal WS through the communication module 160.

For another example, when the heat source HS is detected, the IR temperature sensing module 150 would be turned on to recognize whether the temperature of an apparatus is too high or not. If the temperature of the apparatus is too high, the controller 130 generates the warning signal WS through the communication module 160.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A sensing device, comprising:
a Passive Infrared sensor (PIR sensor), including a plurality sensing elements, wherein the PIR sensor is used to detect a heat source;
a radiation emitter; and
a controller, connected to the radiation emitter and the PIR sensor;
wherein the controller enables the radiation emitter to emit a radiation light to the PIR sensor when the sensing elements reach a voltage balance for a predetermined time and then disables the radiation emitter.

2. The sensing device according to claim 1, wherein the predetermined time is less than a time interval for switching an electronic device.

3. The sensing device according to claim 1, wherein the controller disables the radiation emitter after the radiation emitter emits the radiation light for a default time.

4. The sensing device according to claim 1, wherein the controller disables the radiation emitter after the sensing elements of the PIR sensor reach another voltage balance.

5. The sensing device according to claim 1, wherein the radiation emitter faces the PIR sensor.

6. The sensing device according to claim 1, wherein an energy received from the radiation light of the radiation emitter is larger than an energy received from the heat source.

7. The sensing device according to claim 1, wherein the radiation emitter is fixed.

8. The sensing device according to claim 1, wherein the controller determines whether there is the heat source according to a surge signal generated from the sensing elements having a voltage imbalance.

9. The sensing device according to claim 8, wherein the voltage imbalance is caused by a motion of the heat source or a presence of the heat source.

10. The sensing device according to claim 1, wherein the controller ignores a surge signal generated from the sensing elements having a voltage imbalance caused by the radiation light emitted from the radiation emitter.

11. An operation method of a sensing device, comprising:
enabling a radiation emitter to emit a radiation light to a Passive Infrared sensor (PIR sensor) when a plurality of sensing elements of the PIR sensor reach a voltage balance for a predetermined time; and
disabling the radiation emitter after the radiation emitter is enabled.

12. The operation method of the sensing device according to claim 11, wherein the predetermined time is less than a time interval for switching an electronic device.

13. The operation method of the sensing device according to claim 11, wherein the step of disabling the radiation emitter is executed after the radiation emitter emits the radiation light for a default time.

14. The operation method of the sensing device according to claim 11, wherein the step of disabling the radiation emitter is executed after the sensing elements of the PIR sensor reach another voltage balance.

15. The operation method of the sensing device according to claim 11, wherein the radiation emitter faces the PIR sensor.

16. The operation method of the sensing device according to claim 11, wherein an energy received from the radiation light of the radiation emitter is larger than an energy received from the heat source.

17. The operation method of the sensing device according to claim 11, wherein the radiation emitter is fixed.

18. The operation method of the sensing device according to claim 11, wherein whether there is the heat source is determined according to a surge signal generated from the sensing elements having a voltage imbalance.

19. The operation method of the sensing device according to claim 18, wherein the voltage imbalance is caused by a motion of the heat source or a presence of the heat source.

20. The operation method of the sensing device according to claim 11, wherein a surge signal generated from the sensing elements having a voltage imbalance caused by the radiation light emitted from the radiation emitter is ignored.
